(19) United States
(12) Patent Application Publication
(10) Pub. No.: US 2014/0052909 A1
(43) Pub. Date: Feb. 20, 2014

(54) CONTROL SYSTEM AND METHOD FOR STORAGE CONFIGURATION

(71) Applicant: HON HAI PRECISION INDUSTRY CO., LTD., New Taipei (TW)

(72) Inventor: HSIEN-CHUAN LIANG, New Taipei (TW)

(73) Assignee: HON HAI PRECISION INDUSTRY CO., LTD., New Taipei (TW)

(21) Appl. No.: 13/951,508

(22) Filed: Jul. 26, 2013

(30) Foreign Application Priority Data
Aug. 16, 2012 (TW) 101129817

(51) Int. Cl. G06F 3/06

(52) U.S. Cl. CPC G06F 3/0629; G06F 3/0674; G06F 3/0608
USPC 711/112

(57) ABSTRACT

A control system for storage configuration of a first computer includes a switch apparatus and a storage module. The switch apparatus determines whether a second computer or a hard disk drive (HDD) is connected to a first interface of the switch apparatus. The second computer accesses the storage module of the first computer in response to the storage module being idle. The HDD is added to the storage of the first computer to expand the storage space of the first computer in response to the HDD being connected to the first interface.

### BACKGROUND

1. Technical Field

The present disclosure relates to a control system for storage configuration.

2. Description of Related Art

In order to expand storage space of a computer, a hub may be used to connect two computers. A network address of each computer then needs to be configured, so as to allow access between the computers. However, this is inconvenient and time-consuming to configure the computers.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a control system, which includes a control module.

FIG. 2 is a block diagram showing the control system of FIG. 1 in a use state.

FIG. 3 is a block diagram of the control module of FIG. 1.

FIG. 4 is a flow chart of an embodiment of a control method of the present disclosure.

### DETAILED DESCRIPTION

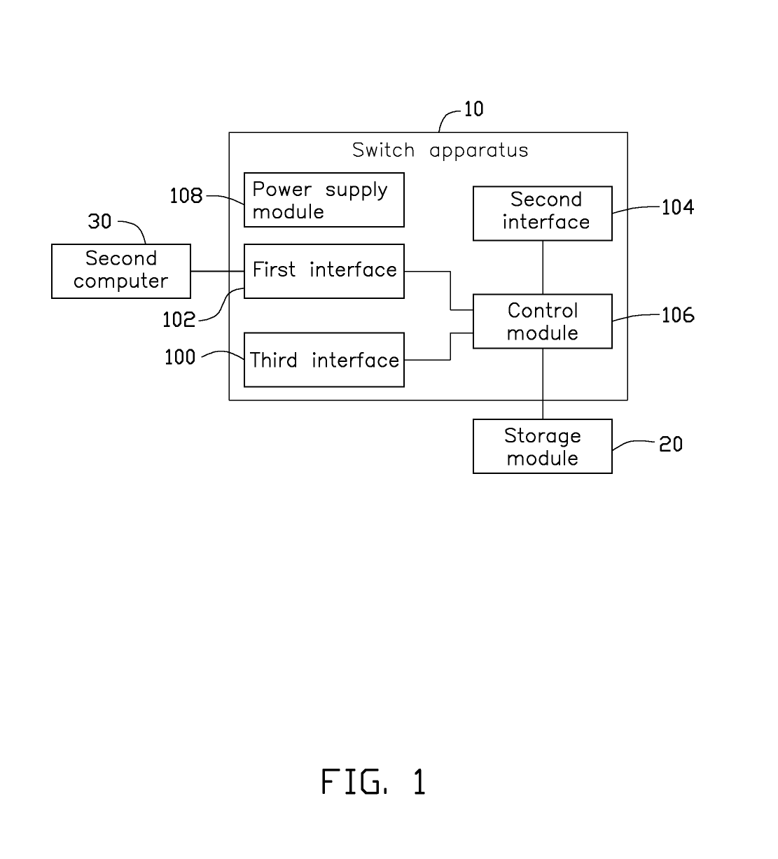

FIG. 1 shows an embodiment of a control system for storage configuration. The control system includes a first interface 102, a second interface 104, a third interface 100, a control module 106, a power supply module 108, and a storage module 20. The first interface 102, the second interface 104, the third interface 100, the control module 106, and the power supply module 108 are arranged on a switch apparatus 10. The storage module 20 includes a plurality of hard disk drives (HDDs).

In the embodiment, the third interface 100 is an external serial advanced technology attachment (eSATA) interface, the first interface 102 is a compatibility serial advanced technology attachment (cSATA) interface, and the second interface 104 is a peripheral component interconnect express (PCIe) interface. The cSATA interface is a self-definable serial interface with substantially the same functionality as the eSATA interface. When a computer or an HDD is connected to the first interface 102, the control module 106 communicates with the computer or the HDD through the first interface 102. When an HDD is connected to either the first interface 102 or the third interface 100, the power supply module 108 supplies power for the HDD.

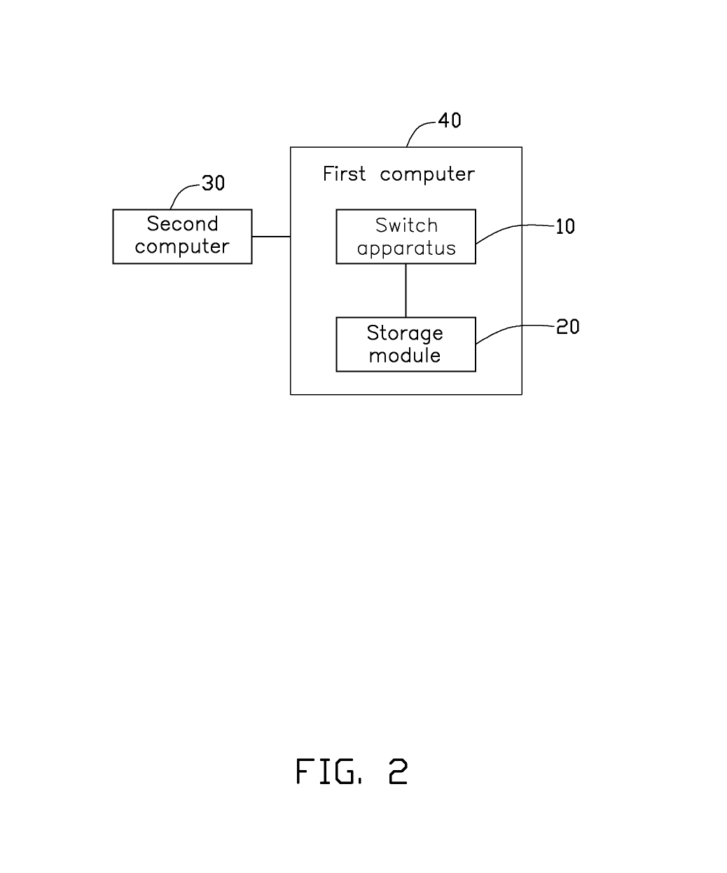

FIG. 2 shows that the switch apparatus 10 and the storage module 20 are arranged in a first computer 40. In the embodiment, the switch apparatus 10 is connected to the first computer 40 through the second interface 104. A second computer 30 is coupled to the switch apparatus 10 through the first interface 102 for accessing the storage module 20.

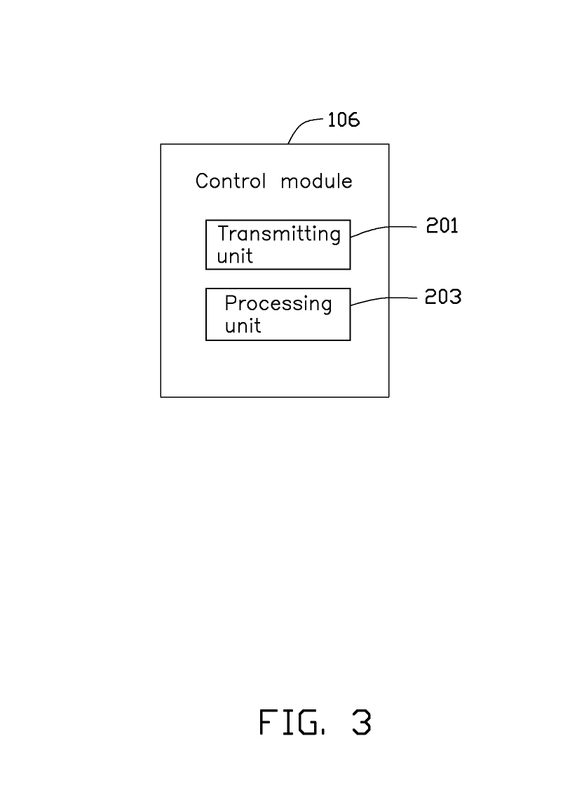

FIG. 3 shows that the control module 106 includes a transmitting unit 201 and a processing unit 203. The transmitting unit 201 transmits data between the storage module 20 and the first to third interfaces 102, 104, and 100.

The processing unit 203 determines whether the first interface 102 is connected to a computer motherboard or a HDD, and whether the third interface 100 is connected to a HDD, by transmitting detection signals to the first and third interfaces 102 and 100. For example, when the processing unit 203 outputs a detection signal to the first interface 102, if a HDD is connected to the first interface 102, the HDD sends back a first conforming signal to the processing unit 203 through the first interface 102 and the transmitting unit 201, in that order. Hence, the processing unit 203 determines that the HDD is connected to the first interface 102 when the processing unit 203 receives the first conforming signal. Alternatively, if the second computer 30 is connected to the first interface 102, the second computer 30 outputs a second conforming signal to the processing unit 203. Thus, the processing unit 203 determines that the second computer 30 is connected to the first interface 102.

If the HDD is connected to the first interface 102 or the third interface 100, the processing unit 203 adds the HDD to the storage module 20 to expand the storage space of the first computer 40. Accordingly, the first computer 40 can access the HDD through the first interface 102 or the third interface 100.

If the second computer 30 is connected to the first interface 102, the processing unit 203 obtains states of the storage module 20. In the embodiment, the state of the storage module 20 is either an operation state or an idle state. When the storage module 20 is in the operation state, which indicates that the first computer 40 is accessing the storage module 20. The processing unit 203 sets an interrupt to the first computer 40, thereby stopping the first computer 40 to perform the operation on the storage module 20, the processing unit 203 then stores the data being handled by the first computer 40, so as to prevent data from being lost After that, the second computer 30 can access data stored in the storage module 20 of the first computer 40 through the first interface 102.

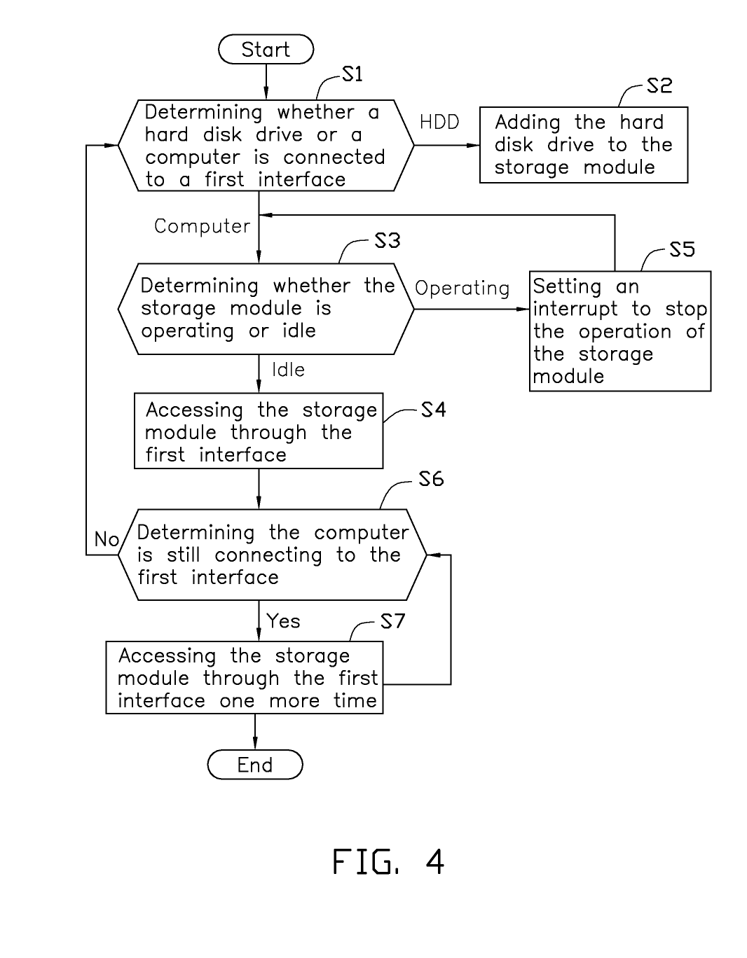

FIG. 4 shows that the control method of the present disclosure includes the following steps.

In step S1, the processing unit 203 determines whether a HDD is connected to the first interface 102 or the third interface 100, or whether the second computer 30 is connected to the first interface 102. If an HDD is connected to the first interface 102 or the third interface 100, step S2 is implemented; if the second computer 30 is connected to the first interface 102, step S3 is implemented.

In step S2, the processing unit 203 adds the HDD to the storage module 20 to expand the storage space of the first computer 40.

In step S3, the processing unit 203 determines the state of the storage module 20. If the storage module 20 is operating, step S5 is implemented; if the storage module 20 is idle, step S4 is implemented.

In step S4, the second computer 30 accesses the storage module 20 through the first interface 102, and the process goes to step S6.

In step S5, the processing unit 203 sets an interrupt to stop the operation of the storage module 20, and the process returns to step S3.

In step S6, the processing unit 203 determines whether the second computer 30 is still connected to the first interface 102. If the second computer 30 is still connected to the first interface 102, step S7 is implemented; if the computer is disconnected from the first interface 102, the process returns to step S1.

In step S7, the processing unit 203 allows the second computer 30 to access the storage module 20.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A control system, comprising:
a first computer, comprising:
a storage module; and
a switch apparatus connecting to the storage module, the switch apparatus comprising a first interface, a second interface connected to a first computer, and a control module connected between the storage module and the first and second interfaces, the control module executing programs stored in the storage module and comprising:
a transmitting unit receiving data from the first and second interfaces; and
a processing unit determining whether a second computer or a hard disk drive (HDD) is connected to the first interface;
wherein when the second computer is connected to the first interface, the processing unit determines a state of the storage module, when the storage module is idle, the processing unit prompts the second computer to communicate with the storage module through the first interface; when the storage module is operating, the processing unit sets an interrupt to the first computer to stop the operation of the storage module, and prompts the second computer to communicate with the storage module through the first interface; when the HDD is connected to the first interface, the processing unit adds the HDD to the storage module.

2. The control system of claim 1, wherein the switch apparatus further comprises a third interface, when a HDD is connected to the third interface, the processing unit adds the HDD to the storage module.

3. The control system of claim 2, wherein the switch apparatus further comprises a power supply module, when a HDD is connected to the first or third interface, the power supply module supplies power for the HDD.

4. The control system of claim 2, wherein the first interface is a compatibility serial advanced technology attachment interface, the second interface is a peripheral component interconnect express interface, and the third interface is an external serial advanced technology attachment interface.

5. A control method, comprising:
determining whether a first computer or a hard disk drive (HDD) is connected to a first interface of a switch apparatus;
adding the HDD to a storage module of a second computer in response to the HDD being connected to the first interface by the switch apparatus;
determining whether a state of the storage module is operating or idle in response to the first computer being connected to the first interface;
setting an interrupt to prevent the second computer from accessing the storage module in response to the storage module being operating; and
prompting the first computer to access the storage module in response to the storage module being idle.

6. The control method of claim 5, further comprising:
determining whether the first computer is still connected to the first interface; and
prompting the first computer to access the storage module in response to the first computer being connected to the first interface.

7. The control method of claim 6, further comprising:
determining whether a HDD is connected to a third interface;
adding the HDD to the storage module in response to the HDD being connected to the third interface.

8. The control method of claim 7, wherein the first interface is a compatibility serial advanced technology attachment interface, the second interface is a peripheral component interconnect express interface, and the third interface is an external serial advanced technology attachment interface.
